(19) United States
(12) Patent Application Publication
(10) Pub. No.: US 2008/0251185 A1
(43) Pub. Date: Oct. 16, 2008

(54) Device, an installation, and a method for applying a rubber strip against a tire blank

(75) Inventors: Bernard Cappa, Lempdes (FR); Arnaud Letocart, Combronde (FR)

Correspondence Address: COHEN PONTANI LIEBERMAN & PAVANE LLP, Suite 1210, 551 Fifth Avenue, New York, NY, 10176, US

(73) Assignee: Michelin Recherche et Technique S.A., Granges-Paccot (CH)

(21) Appl. No.: 12/080,938

(22) Filed: Apr. 7, 2008

(30) Foreign Application Priority Data
Apr. 5, 2007 (FR) 07/54298

(51) Int. Cl. B29D 30/14

(52) U.S. Cl. 156/117; 156/397

(57) ABSTRACT

A device that enables a rubber strip to be applied to a tire blank. The device comprises a rubber extruder provided with an extrusion orifice for shaping the rubber strip and delivering said strip from the extruder. The orifice is defined by a roller mounted to rotate on the extruder. The device further comprises thrust means for thrusting the roller against the blank so that the roller constitutes an applicator for applying the rubber strip against the blank. The extruder is mounted to pivot about an axis so as to form a lever on which the thrust means act to thrust the roller against the strip.

### RELATED APPLICATIONS

This application claims priority from French Patent Application Serial Number 0754298 filed on Apr. 5, 2007 the content of which is hereby incorporated by reference.

### FIELD OF THE INVENTION

The present invention relates to a device, an installation, and a method for applying a rubber strip against a tire blank.

The invention applies particularly, but not exclusively, to a tire for a motorcycle.

### BACKGROUND OF THE INVENTION

It is known to apply a rubber strip against a tire blank by means of an installation comprising, at a first station, at least one rubber extruder for fabricating a rubber strip, and at a second station, a rotary support for the blank for applying the rubber strip against the blank.

The extruder of the installation is provided with an extrusion orifice (for shaping the rubber strip and for delivering the strip from the extruder) that is advantageously defined by a roller mounted to rotate on the extruder.

In certain circumstances, after fabrication and prior to application against the blank, the rubber strip is stored temporarily on a storage reel. In other circumstances, the rubber strip is transferred directly from the first station to the second station without intermediate storage, possibly passing via means for regulating delivery rates.

In all of the circumstances mentioned above, the strip is extruded and applied in two different stations, thus making it necessary firstly to move the extruded rubber strip from a fabrication station to an application station, and secondly, prior to applying the strip against the blank, to coat the rubber strip with a substance that improves the adhesion of the strip on the blank.

### OBJECTS AND SUMMARY OF THE INVENTION

The object of the present invention is to simplify fabricating the tire blank, in particular by avoiding any need to move and coat the rubber strip between two stations, thereby reducing as much as possible the cost of fabricating a tire.

To this end, one aspect of the invention is directed to a device for applying a strip of rubber on a tire blank, the device being of the type comprising at least one rubber extruder provided with an extrusion orifice for shaping the rubber strip and for delivering said strip from the extruder, this extrusion orifice being defined by a roller mounted to rotate on the extruder, the device further comprising thrust means for thrusting the roller against the blank in such a manner that the roller forms an applicator for applying the rubber strip against the blank.

Such a device makes it possible, at a single station, both to extrude the rubber strip and to apply it against the tire blank. The means for thrusting the roller against the blank enable the rubber strip to be applied against the blank directly at the outlet from the extruder. There is no longer any need to move the strip from one station to another.

In addition, since the rubber strip is relatively hot on leaving the extruder, it bonds easily with the blank under the action of the applicator-forming roller. There is therefore no need to coat the strip with a substance for improving adhesion.

According to an optional characteristic of the device of the invention, the roller is generally in the form of a body of revolution generated by rotating a convex curve about an axis forming the axis of rotation for the roller, in such a manner that the diameter of the roller is at a maximum substantially in the middle of the roller.

During application of the strip against the blank, the convex shape of the roller serves to expel any air that might become interposed between the strip and the blank.

According to another optional characteristic of the device of the invention, the orifice forms the open end of a rubber flow channel, said channel being provided with at least one localized braking projection for braking the flow of rubber in localized manner.

The rubber flows in the channel in a viscoelastic state, so it is sensitive to edge effects tending to slow down the flow of rubber in contact with the outline of the channel. The localized braking projections serve to brake the flow of rubber in the center of the channel so as to form a rubber front that is relatively plane.

According to other optional characteristics of the device of the invention:
The extruder is mounted to pivot about an axis so as to form a lever on which the thrust means act for applying force to the roller.
Presser means for pressing the rubber strip against the blank are secured to the extruder in such a manner as to be thrust against the blank together with the roller. These presser means serve to ensure that the rubber strip is applied perfectly against the blank.
The pivot axis of the extruder is carried by a support forming a portion of a robotic assembly. Such an assembly enables the device of the invention to be adapted to tires presenting different geometrical characteristics. The robotic assembly serves to move the extruder relative to the blank, and thus to adapt to various types of blank.
The device includes two extruders, each provided with a roller and with thrust means for thrusting the roller against the blank, the two extruders being disposed on either side of a mean axial midplane of the blank, so that for the blank being generally in the form of a body of revolution, it is possible to apply rubber strips on two portions of the blank that are symmetrical about the mean axial midplane of the blank.

Another aspect of the invention is directed to an installation for applying a rubber strip against a tire blank, the installation comprising a device as defined above together with a rotary support for the blank.

Another aspect of the invention is directed to a method of applying a rubber strip against a tire blank by means of at least one rubber extruder provided with an extrusion orifice for shaping the rubber strip and providing the outlet for said strip from the extruder, said extrusion orifice being defined by a roller mounted to rotate on the extruder, wherein the roller is thrust against the blank in such a manner that the roller forms an applicator for applying the rubber strip against the blank.

Such a method enables the strip to be applied against the blank while the blank is rotating on the support.

According to an optional characteristic of the method of the invention, for the blank being supported by a rotary support, the speeds of rotation of the rotary support and roller are mutually synchronized.

This makes it possible in particular to adapt the speeds of rotation of the rotary support and roller as a function, amongst other things, of the geometrical parameters of the tire and of the flow rate from the extruder. By synchronizing the speeds of rotation of the rotary support and roller, the speed of the roller is thus adapted to the speed of rotation of the blank.

According to an optional characteristic of the method of the invention, for the strip being applied to the tire blank along a circular path such that the strip presents along said path radially inner and outer edges of different radii, the speeds of rotation of the rotary support and roller are mutually synchronized in such a manner that the circumferential speed of the roller is substantially equal to the circumferential speed of the inner edge of the strip.

It is thus possible to apply a rubber strip against a blank that is already generally toroidal in shape corresponding substantially to the final shape of the tire. On a blank having this shape, and more particularly on a portion of the blank that is to form a sidewall of the tire, the strip is applied against said portion along a path that is circular so that the strip presents a radially inner edge and a radially outer edge of different radii. Because the rubber applied by the roller is relatively hot and in a viscoelastic state, the circumferential speed of the roller that is substantially equal to the circumferential speed of the radially inner edge of the strip leads to the rubber strip being stretched along its radially outer edge, thereby ensuring that the strip as applied is plane and does not present wrinkles.

According to another optional characteristic of the method of the invention, for the extruder including a wormscrew for extruding rubber, a segment of strip is cut off after the segment has been applied to the tire blank by causing the wormscrew to turn in a direction opposite from its extrusion direction.

By using the wormscrew in its direction opposite to its extrusion direction, there is no need to have recourse to additional means for cutting off the strip of rubber.

Advantageously, before or after applying a segment of strip against the tire blank, the roller is caused to turn in a direction opposite to its direction for extrusion and strip application.

This rotation of the roller in the direction opposite to its extrusion direction serves to optimize the shape of the front of rubber.

Another aspect of the invention is directed to a method as described above making use of an installation as described above comprising a device having two extruders, each provided with a roller and with thrust means for thrusting the roller against the blank, the two extruders being disposed on either side of a mean axial midplane of the blank so that for the blank generally being in the form of a body of revolution, it is possible to apply strips of rubber against two portions of the blank that are symmetrical about the mean axial midplane of said blank, wherein a rubber strip is applied simultaneously to each portion of the blank.

### BRIEF DESCRIPTION OF THE DRAWINGS

FIG. 1 is a perspective view of an installation in accordance with an embodiment of the invention;

FIG. 2 is a detail view of the portion indicated by arrow I in FIG. 1, showing the thrust means;

FIG. 3 is a detail view of the portion indicated by arrow II in FIG. 1 showing the presser means;

FIG. 4 is a section view of an extruder roller of a device for applying a strip of rubber in the installation shown in FIG. 1; and

FIG. 5 is a view looking along arrow V in FIG. 4 showing the extruder roller.

### DETAILED DESCRIPTION OF THE DRAWINGS

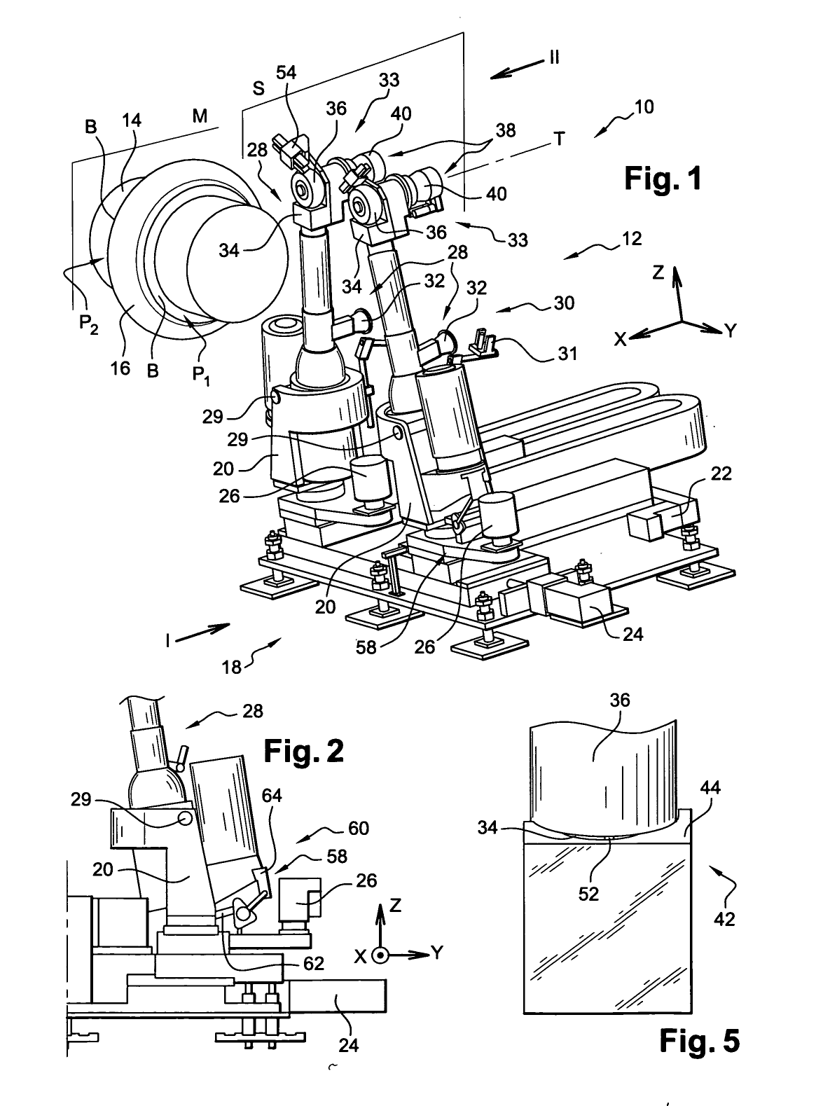

FIG. 1 shows an installation of the invention for applying a strip of rubber on a tire blank. This installation is given overall reference 10.

The installation 10 comprises a device 12 for applying a strip B of rubber, together with a rotary support 14 carrying a uncured tire blank 16 that is generally toroidal in shape, being close to the shape of a vulcanized tire.

The blank 16 shown by way of example in FIG. 1 is, once vulcanized, to constitute a tire for a motorcycle.

The blank 16 is rotated about its axis by the rotary support 14.

The device 12 includes a robotic assembly 18. This robotic assembly 18 carries two supports 20 disposed on either side of a plane S.

FIG. 1 shows a frame of reference having axes X, Y, Z that are mutually orthogonal in pairs such that the support 20 is movable parallel to the X axis by conventional motor-driven means 22, parallel to the Y axis by conventional motor-driven means 24, and about an axis parallel to the Z axis by conventional motor-driven means 26.

It should be observed that the plane S is parallel to the X,Z plane.

The device 12 also has two extruders 28 disposed on either side of the plane S. Each extruder 28 is pivotally mounted about an axis 29, being carried by the corresponding support 20, so as to form a lever. The axis 29 extends substantially parallel to the X axis.

Each extruder 28 includes feeder means 30 for feeding the extruder 28 with rubber. These feeder means 30 include guide means 31 for guiding a non-extruded mass of rubber and introducer means 32 for introducing the non-extruded mass of rubber into the extruder 28.

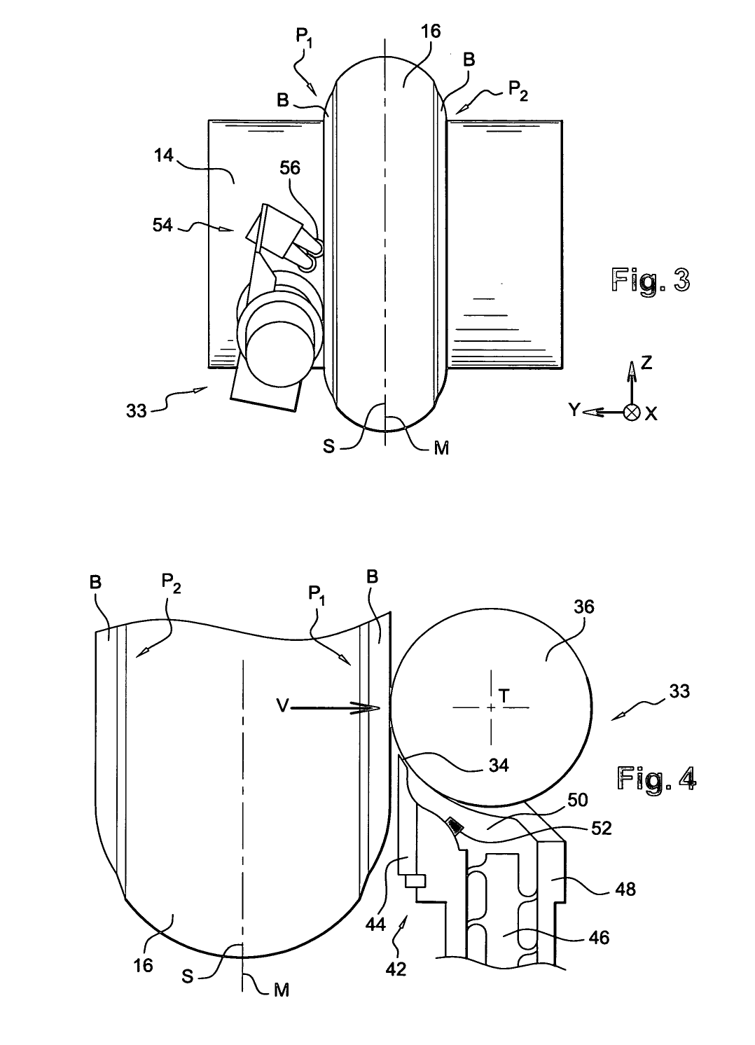

Each extruder 28 also has an extruder head 33. The extruder head 33 is shown in greater detail in FIGS. 3 and 4.

The extruder head 33 includes an orifice 34 serving to shape the strip B of rubber, and also serving as the outlet for said strip B from the extruder 28.

The orifice 34 is defined by a roller 36. As shown in FIG. 1, the roller 36 is mounted to rotate on the extruder 28 and is driven in rotation about an axis T by drive means 38. These drive means 38 comprise in particular a motor 40.

The orifice 34 is also defined by adjustment means 42 for adjusting the profile of the strip B of rubber. Specifically, these adjustment means 42 comprise a removable blade 44.

As shown in FIG. 4, each extruder 28 comprises, in conventional manner, a wormscrew 46 mounted to rotate in a body 48. The screw 46 enables the rubber to be put under pressure and heated along a rubber flow channel 50. The orifice 34 forms an open end of the channel 50 through which rubber is extruded. The channel 50 is provided with at least one localized braking projection 52 for localized braking of the rubber. Specifically, the channel 50 is provided with a single localized braking projection 52 that is also shown in FIG. 5.

In FIG. 5, it can be seen that the roller 36 is generally in the form of a body of revolution obtained by rotating a convex curve around the axis T. The diameter of the roller 36 is at a maximum substantially in the middle of the roller 36.

In the example shown in FIGS. 1 and 3, the extruder head 33 also has presser means 54 for pressing the strip B of rubber against the blank 16. By way of example, these presser means 54 comprise two small wheels 56.

As shown in FIGS. 1 and 2, thrust means 58 associated with each extruder 28 act on the lever-forming extruder 28 so as to thrust the small wheel 36 against the blank 16. In this manner, the wheel 36 constitutes an applicator for pressing the strip B of rubber against the blank 16.

Since the presser means 54 are secured to the head 33 of the extruder 28, they are thrust by the means 58 against the blank 16 together with the roller 36.

The thrust means 58 are disposed in such a manner that the two extruders 28 can press two strips B of rubber against two portions P₁ and P₂ of the blank 16 corresponding to the sidewalls of the future tire. These portions P₁ and P₂ are symmetrical about a mean axial midplane M of the blank 16, as shown in FIG. 1.

As shown in FIG. 2, the thrust means 58 comprise an assembly forming a hinged arm 60 having a first end 62 connected to the support 20 and a second end 64 connected to an end of the extruder 28 that is on the side of the axis 29 opposite from the side on which the head 33 is located.

Each extruder 28 of the installation 10 enables the strip B of rubber to be pressed against the blank 16 of the tire in application of the method for which the main aspects associated with the invention are described below.

Firstly, the support 14 is placed close to the device 12 so that the blank extends in part between the extruders 28, the plane S of the device 12 coinciding with the mean axial midplane M of the blank 16.

Then the roller 36 is pressed against the blank 16 so that this roller 36 forms an applicator for applying the strip B of rubber against the blank 16. The rubber strip B is then applied against a portion of the blank 16 (e.g. a sidewall) as follows.

The speeds of rotation of the support 14 and of the rotary roller 36 are mutually synchronized. The extruded rubber strip B is optionally heated by heating the roller 36 by conventional means that are not shown.

Thereafter, the strip B is deposited on the tire blank 16 around a circular path. Because its path is circular, the strip B presents edges that are radially inner and outer and that have different radii. The speeds of rotation of the support 14 and of the roller 36 are preferably synchronized in such a manner that the circumferential speed of the roller 36 is substantially equal to the circumferential speed of the inner edge of the strip B.

After a segment of rubber strip B has been applied to the blank 16, the segment is cut by causing the screw 46 to turn in a direction opposite to its direction for extruding rubber. Preferably, in order to optimize the shape of the rubber front after the strip B has been cut, the roller 36 is caused to rotate in a direction opposite to its direction for extruding and applying the strip B.

It should be observed that prior to applying the segment of strip B against the blank 16, it is also possible to cause the roller 36 to turn in its direction opposite to its extrusion direction.

It should also be observed that two rubber strips B can be applied simultaneously to the two portions P₁ and P₂ of the blank 16.

An implementation of the invention described herein relates to fabricating a tire blank for a motorcycle. For this particular application, the invention makes it very easy to apply a strip of rubber along a circular path such that all along the path the strip presents edges of different radii, with this being possible because the rubber is still hot while it is being applied against the blank. This advantage is particularly useful for taking account of the generally toroidal shape of a tire blank for a motorcycle, in particular of the generally rounded shape of the crest of the blank, which constrains application of the rubber strip to follow circular paths, as described above.

It will readily be understood that the invention is not restricted to the embodiment described above and that it can also be implemented to fabricate any type of tire cover, e.g. for a private vehicle, a van, or indeed a heavy goods vehicle.

In addition, the strip B may be deposited on any portion of the blank 16, e.g. on the crown of the blank (future tread of the tire), along a path that is circular or otherwise.

What is claimed is:

1. A device for applying a strip of rubber on a tire blank, comprising:
at least one rubber extruder provided with an extrusion orifice, for shaping the rubber strip and for delivering said strip from the extruder, this extrusion orifice being defined by a roller mounted to rotate on the extruder; and
thrust means for thrusting the roller against the blank in such a manner that the roller forms an applicator for applying the rubber strip against the blank.

2. The device according to claim 1, in which the roller is generally in the form of a body of revolution generated by rotating a convex curve about an axis forming the axis of rotation for the roller, in such a manner that the diameter of the roller is at a maximum substantially in the middle of the roller.

3. The device according to claim 1, in which the orifice forms the open end of a rubber flow channel, said channel being provided with at least one localized braking projection for braking the flow of rubber in localized manner.

4. The device according to claim 1, in which the extruder is mounted to pivot about an axis so as to form a lever on which the thrust means act for applying force to the roller.

5. The device according to claim 4, in which presser means for pressing the rubber strip against the blank are secured to the extruder in such a manner as to be thrust against the blank together with the roller.

6. The device according to claim 4, in which the pivot axis of the extruder is carried by a support forming a portion of a robotic assembly.

7. The device according to claim 1, having two extruders each provided with a roller and with thrust means for thrusting the roller against the blank, the two extruders being disposed on either side of a mean axial midplane of the blank so that for the blank being generally in the form of a body of revolution, it is possible to apply rubber strips on two portions of the blank that are symmetrical about the mean axial midplane of the blank.

8. An installation for applying a rubber strip against a tire blank, the installation comprising a device according to claim 1 together with a rotary support for the blank.

9. A method of applying a rubber strip against a tire blank by means of at least one rubber extruder provided with an extrusion orifice for shaping the rubber strip and providing the outlet for said strip from the extruder, said extrusion orifice being defined by a roller mounted to rotate on the extruder, wherein the roller is thrust against the blank in such a manner that the roller forms an applicator for applying the rubber strip against the blank.

10. The method according to claim 9, in which, since the blank is supported by a rotary support, the speeds of rotation of the rotary support and roller are mutually synchronized.

11. The method according to claim 10, in which, for the strip being applied to the tire blank along a circular path such that the strip presents along said path radially inner and outer edges of different radii, the speeds of rotation of the rotary support and roller are mutually synchronized in such a manner that the circumferential speed of the roller is substantially equal to the circumferential speed of the inner edge of the strip.

12. The method according to claim 9, in which, for the extruder including a wormscrew for extruding rubber, a segment of strip is cut off after the segment has been applied to the tire blank by causing the wormscrew to turn in a direction opposite from its extrusion direction.

13. The method according to claim 9, in which, before or after applying a segment of strip against the tire blank, the roller is caused to turn in a direction opposite to its direction for extrusion and strip application.

14. The method according to claim 9 performed by means of an installation for applying a rubber strip against a tire blank, the installation comprising a device for applying a strip of rubber on a tire blank,
the device being of the type comprising two rubber extruders each provided with an extrusion orifice, for shaping the rubber strip and for delivering said strip from the extruder, each extrusion orifice being defined by a roller mounted to rotate on the extruder,
the device further comprising thrust means for thrusting each roller against the blank in such a manner that each roller forms an applicator for applying the rubber strip against the blank, the two extruders being disposed on either side of a mean axial midplane of the blank so that for the blank being generally in the form of a body of revolution, it is possible to apply rubber strips on two portions of the blank that are symmetrical about the mean axial midplane of the blank,
wherein a rubber strip is applied simultaneously to each portion of the blank.
